(19) United States
(12) Patent Application Publication
(10) Pub. No.: US 2019/0334173 A1
(43) Pub. Date: Oct. 31, 2019

(54) COMPOSITE GRAPHITE PARTICLES, METHOD FOR PRODUCING SAME, AND USE THEREOF

(71) Applicant: SHOWA DENKO K. K., Tokyo (JP)

(72) Inventors: Ayaka IKADO, Tokyo (JP); Daisuke KONO, Tokyo (JP); Shunsuke YOSHIOKA, Tokyo (JP); Yasuaki WAKIZAKA, Tokyo (JP); Akihisa TONEGAWA, Tokyo (JP); Daisuke HARADA, Tokyo (JP)

(73) Assignee: SHOWA DENKO K. K., Tokyo (JP)

(21) Appl. No.: 16/468,039

(22) PCT Filed: Nov. 27, 2017
(86) PCT No.: PCT/JP2017/042420

§ 371 Date: Jun. 10, 2019

(30) Foreign Application Priority Data
Dec. 12, 2016 (JP) 2016-240394

(51) Int. Cl. H01M 4/587; H01M 4/36; H01M 4/62; H01M 10/0525; C01B 32/205

(52) U.S. Cl. CPC H01M 4/587; H01M 4/366; H01M 2004/027; H01M 10/0525; C01B 32/205; H01M 4/625

(57) ABSTRACT

Composite graphite particles, including a core material composed of artificial graphite and a coating material for coating the core material. The coating material includes a non-powdery amorphous carbon material and a powdery conductive carbon material. The ratio of the mass of the non-powdery amorphous carbon material to the mass of the core material is 0.2 to 3.8 mass %, and the ratio of the mass of the powdery conductive carbon material to the mass of the core material is 0.3 to 5.0 mass %. Also disclosed is a method for producing the composite graphite particles, a paste containing the composite graphite particles, an electrode sheet including a laminate of a current collector and an electrode layer containing the composite graphite particles, and a lithium ion secondary battery including the electrode sheet as a negative electrode.

### TECHNICAL FIELD

The present invention relates to composite graphite particles, a method for producing the same, and use thereof. Specifically, the present invention relates to composite graphite particles useful as a negative electrode material to obtain a lithium ion secondary battery and the like having a low internal resistance value, excellent input/output characteristics, and excellent cycle characteristics; a method for producing the same; and an electrode sheet and a lithium ion secondary battery using the composite graphite particles.

### BACKGROUND ART

A lithium ion secondary battery is used as a power source of a mobile device or the like. A lithium ion secondary battery initially faced many problems such as battery capacity shortage and short charge/discharge cycle life. In the present day, such problems have been solved one by one, and lithium ion secondary batteries have expanded in application from light electrical appliance such as mobile phones, notebook computers and digital cameras to heavy electrical machinery such as electric tools and electrical vehicles which require more power. In addition, lithium ion secondary batteries are particularly expected to be used as a power source of automobiles, and research and development of electrode materials and a cell structure have become active. Among others, there is a growing need for a lithium ion secondary battery having high input/output (rapid charge/discharge) characteristics due to a demand for hybrid electric vehicles (HEV) and the like. Along with that, high input/output characteristics have been required for the negative electrode active material of a lithium ion secondary battery. Negative electrode materials with use of various inventiveness to improve input/output characteristics have been used in a battery for HEV and the like but further improvement of the characteristics has been demanded as it now stands.

As a negative electrode material for a lithium ion secondary battery, carbon-based materials and metal-based materials have been developed. In the carbon-based materials, there are a carbon material having high crystallinity such as graphite and a carbon material having low crystallinity such as amorphous carbon. Both of them are capable of intercalation/deintercalation reaction of lithium ions and therefore can be used for a negative electrode active material.

It is known that a battery obtained from a high crystallinity carbon material has a high capacity but shows marked deterioration in cycle characteristics. In contrast, a battery obtained from a low crystallinity carbon material has a relatively low internal resistance value and stable cycle characteristics but has a low battery capacity.

It has been proposed to form a complex of a low crystallinity carbon material and a high crystallinity carbon material to mutually make up for deficiencies of a low crystallinity carbon material and a high crystallinity carbon material.

For example, Patent Document 1 discloses a technology to coat a surface of natural graphite with amorphous carbon by mixing natural graphite and pitch and subjecting the mixture to heat treatment at 900 to 1,100° C. in an inert gas atmosphere. Patent Document 2 discloses a technology to immerse a carbon material serving as a core material in tar or pitch, followed by drying or heat treatment at 900 to 1,300° C.

Patent Document 3 discloses a technology to coat a surface of graphite particles obtained by granulating natural graphite or flaky artificial graphite with a carbon precursor such as pitch and then to fire the graphite particles within a temperature range of from 700 to 2,800° C. in an inert gas atmosphere.

Furthermore, Patent Document 4 discloses using composite graphite particles as a negative electrode active material, which composite graphite particles can be obtained by coating spherical graphite particles obtained by granulating and spheroidizing flaky graphite by a mechanical external force, which flaky graphite has an average interplanar spacing (002) plane, d₀₀₂, of 0.3356 nm; a ratio between the peak intensity of a peak at 1360 cm⁻¹ (I₁₃₆₀) and the peak intensity of a peak at 1580 cm⁻¹ (I₁₅₈₀) measured by a Raman spectrometric method, I₁₃₆₀/I₁₅₈₀ (R value: the same as I_{D}/I_{G} of the present invention) of around 0.07; and a thickness in a C-axis direction of crystallite, Lc, of around 50 nm, with a carbide obtained by heating resin such as phenol resin.

### PRIOR ART

### Patent Documents

Patent Document 1: JP 2005-285633 A

Patent Document 2: Japan Patent No. 2976299 (corresponding to US 2004/151837 A1)

Patent Document 3: Japan Patent No. 3193342 (corresponding to U.S. Pat. No. 6,403,259 B1)

Patent Document 4: JP 2004-210634 A

### DISCLOSURE OF THE INVENTION

### Problems to be Solved by the Invention

Composite graphite particles as described above have been widely used for a conventional lithium ion secondary battery. However, natural graphite to be used as a core material is inferior in cycle characteristics due to its structure and not suitable as a member for a HEV battery for which high input/output characteristics and high durability are required. On the other hand, it is often the case that artificial graphite obtained by graphitizing a precursor such as coke at high temperature has good cycle characteristics compared to natural graphite. However, higher input/output characteristics are required for a lithium ion battery as a power source for HEV compared to a conventional lithium ion battery and therefore a negative electrode material satisfying the required properties has not been developed yet as it stands.

An objective of the present invention is to provide composite graphite particle as a negative electrode material that makes it possible to obtain a lithium ion secondary battery having a low internal resistance value, excellent input/output characteristics and good cycle characteristics; a method for producing the composite graphite particles; an electrode sheet and a lithium ion secondary battery using the same.

The present invention comprises structures as below.

[1] Composite graphite particles, comprising a core material composed of artificial graphite and a coating material for coating the core material, which coating material includes a non-powdery amorphous carbon material and a powdery conductive carbon material; wherein the ratio of the mass of the non-powdery amorphous carbon material to the mass of the core material is 0.2 to 3.8 mass %, and the ratio of the mass of the powdery conductive carbon material to the mass of the core material is 0.3 to 5.0 mass %.
[2] The composite graphite particles according to [1] above, wherein the ratio of the mass of the non-powdery amorphous carbon material to the mass of the core material is 0.2 to 2.3 mass %.
[3] The composite graphite particles according to [1] or [2] above, wherein the ratio of the mass of the powdery conductive carbon material to the ratio of the mass of the core material is 0.3 to 3.0 mass %.
[4] The composite graphite particles according to any one of [1] to [3] above, wherein the powdery conductive carbon material is carbon black.
[5] The composite graphite particles according to any one of [1] to [4] above, wherein a ratio between the peak intensity of a peak in the vicinity of 1360 cm⁻¹ (I_{D}) and the peak intensity of a peak in the vicinity of 1580 cm⁻¹ (I_{G}) measured in a spectrum by Raman spectroscopy, I_{D}/I_{G} (R value), is 0.10 to 1.00.
[6] The composite graphite particles according to any one of [1] to [5] above, wherein a BET specific surface area based on nitrogen adsorption is 1.5 to 10.0 m²/g.
[7] A method for producing the composite graphite particles according to any one of [1] to [6] above, comprising adding 0.3 to 5.0 parts by mass of an amorphous carbon precursor and 0.3 to 5.0 parts by mass of a powdery conductive carbon material to 100 parts by mass of artificial graphite, mixing the resultant while applying shear force, and firing the obtained mixture at 600 to 1,300° C.
[8] The method producing the composite graphite particles according to [7] above, wherein the amorphous carbon precursor is at least one compound selected from a group consisting of petroleum-based pitch, coal-based pitch, phenol resin, polyvinyl alcohol resin, furan resin, cellulose resin, polystyrene resin, polyimide resin and epoxy resin.
[9] The method producing the composite graphite particles according to [8] above, wherein the amorphous carbon precursor is petroleum-based pitch.
[10] A paste containing the composite graphite particles according to any one of [1] to [6] above, a binder and a solvent.
[11] The paste according to [10] above, further containing a powdery conductive carbon material.
[12] An electrode sheet, which is composed of a laminate comprising a current collector and an electrode layer containing the composite graphite particles according to any one of [1] to [6] above.
[13] The electrode sheet according to [12] above, wherein the electrode layer further contains a powdery conductive carbon material.
[14] A lithium ion secondary battery comprising the electrode sheet according to [12] or [13] above as a negative electrode.

### Effects of Invention

The composite graphite particles of the present invention contains a powdery conductive carbon material such as carbon black in a coating layer of a non-powdery amorphous carbon material for coating the graphite particles. As a result, the electron conductivity of the electrode layer is improved. In addition, the conductive carbon material is highly reactive with lithium ions and therefore the effective reactive area with lithium ions increases. Accordingly, a lithium ion secondary battery obtained by using the composite graphite particles of the present invention is improved in input/output characteristics. That is, the battery has good charge/discharge characteristics under a large current load. Carbon black is coated with a non-powdery amorphous carbon material and therefore the electrolyte is not to be reduced with carbon black. As a result, the reduction in the initial efficiency of the battery is suppressed and good cycle characteristics can be attained.

### Mode for Carrying out Invention

[Composite Graphite Particles]

The composite graphite particles in a preferable embodiment of the present invention comprises a core material composed of graphite and a coating material to coat the core material, which coating material comprises a non-powdery amorphous carbon material and a powdery conductive carbon material.

The graphite constituting the core material is artificial graphite obtained by subjecting graphite precursor such as coke, coal and pitch, or graphite to heat treatment (graphitization treatment). As a graphite precursor, coke or coal is preferable in terms of easiness in handling.

A green coke or a calcined coke can be used as a coke. As a raw material of the coke, for example, coal pitch, petroleum pitch, and a mixture thereof can be used. Particularly preferred is a calcined coke obtained by further heating the green coke under an inert atmosphere, wherein the green coke is obtained by the delayed coking treatment under specific conditions.

The graphitization treatment temperature is generally 2500° C. or more and 3500° C. or less, preferably 2800° C. or more and 3500° C. or less, more preferably 2800° C. or more and 3300° C. or less. When the treatment temperature is lower than 2500° C., a discharge capacity of the obtained lithium ion secondary battery is reduced. It is desirable to perform the graphitization treatment in an inert atmosphere. The graphitization treatment time can be appropriately selected depending on the processing quantity and the type of graphitization furnace, and there is no particular limit. The graphitization treatment time is, for example, around 10 minutes to around 100 hours. The graphitization treatment can be performed by, for example, using Acheson graphitization furnace.

The artificial graphite constituting the core material has an average interplanar spacing (002) plane (d₀₀₂) of preferably 0.3354 to 0.3370 nm, more preferably 0.3354 to 0.3356 nm. A thickness in a C-axis direction of crystallite (Lc) is preferably 50 nm or more, more preferably 100 nm or more.

d₀₀₂ and Lc can be measured using a powder X-ray diffraction method by a known method (see M. Inagaki, “Tanso”, 1963, No. 36, pages 25-34; Iwashita et al., Carbon, vol. 42 (2004) pages 701-704).

The coating layer for coating the core material comprises a non-powdery amorphous carbon material and a powdery conductive carbon material. The non-powdery amorphous carbon material can be obtained by subjecting a precursor such as coal-based pitch, petroleum-based pitch and resin to heat treatment. Examples of the resin include at least one compound selected from the group consisting of a phenol resin, a polyvinyl alcohol resin, a furan resin, a cellulose resin, a polystyrene resin, a polyimide resin, and an epoxy resin. Of those, coal-based pitch and petroleum-based pitch are preferred in that they are inexpensive, have a high residual carbon ratio, and exert good battery characteristics when they are used as a precursor of the coating layer. Among coal-based pitch and petroleum-based pitch, petroleum-pitch is more preferable in that a high initial efficiency can be obtained and that it has low toxicity. Both of isotropic pitch and anisotropic pitch can be used. Of these, a pitch having a high softening point from 100° C. or more and 300° C. or less is particularly preferable due to ease in handling.

A powdery conductive carbon material is carbon black or carbon fiber. Specifically, carbon black such as acetylene black and Ketjenblack, and carbon fiber such as carbon nanotubes and carbon nanofiber can be used. Of these, carbon black is preferred because it is easy to uniformly coat the surface of graphite particles with carbon black and it is inexpensive.

In a preferable embodiment of the present invention, the ratio of the mass of the non-powdery amorphous carbon material to the mass of the core material is 0.2 to 3.8 mass %, preferably 0.2 to 2.3 mass %, more preferably 0.4 to 1.5 mass %. When the ratio of the mass of the non-powdery amorphous carbon material is too high, it results in marked decrease in the density of the negative electrode active material layer when the negative electrode comprising the composite graphite particles as an active substance is pressed, and the discharge capacity of a lithium ion secondary battery using the negative electrode tends to decrease. When the ratio of the mass of the non-powdery amorphous carbon material is too low, a powdery conductive carbon material does not adhere to the surface of the core material or a powdery conductive carbon material is exposed and therefore the initial efficiency of a battery tends to be reduced.

The ratio of the mass of the powdery conductive carbon material to the mass of the core material is 0.3 to 5.0 mass %, preferably 0.3 to 3.0 mass %, more preferably 0.5 to 2.0 mass %, still more preferably 0.5 to 1.5 mass %. When the ratio of the mass of the powdery conductive carbon material is too high, it results in marked decrease in the density of the negative electrode active material layer when the negative electrode comprising the composite graphite particles as an active substance is pressed, and the initial efficiency of a lithium ion secondary battery using the negative electrode tends to decrease. When the ratio of the mass of the powdery conductive carbon material is too low, the effects of improving conductivity and increasing effective reactive area with lithium ions tend not to be obtained.

In order to obtain the above-described ratio of the mass of the powder amorphous carbon material in the mixed graphite particles, the ratio of the mass of the amorphous carbon precursor is to be set to higher than the ratio of the mass of the non-powdery amorphous carbon material which is finally formed as a coating layer in consideration of the residual carbon ratio of the amorphous carbon precursor at the time of firing after mixing the core material (artificial graphite particles), amorphous carbon precursor and a powdery conductive carbon material. Specifically, the ratio of the mass of the amorphous carbon precursor to be mixed in 100 parts by mass of artificial graphite as a core material is 0.3 to 5.0 parts by mass, preferably 0.2 to 3.0 parts by mass, more preferably 0.5 to 2.0 parts by mass.

In contrast, there is no weight loss by firing in a powdery conductive carbon material and therefore the ratio of the mass thereof to be mixed in 100 parts by mass of artificial graphite as a core material is the same as the above-described ratio of the mass of the powdery conductive carbon material to the mass of the core material in the mixed graphite particles. Specifically, the ratio of the mass of the powdery conductive carbon material to be mixed in 100 parts by mass of artificial graphite as a core material is 0.3 to 5.0 parts by mass, preferably 0.3 to 3.0 parts by mass, more preferably 0.5 to 2.0 parts by mass, still more preferably 0.5 to 1.5 mass %.

In order to form a coating layer comprising a non-powdery amorphous carbon material and a powdery conductive carbon material on the surface of a core material composed of artificial graphite, firstly artificial graphite as a core material, a precursor of the amorphous carbon material and a powdery conductive carbon material are mixed while applying shear force to allow a non-powdery amorphous carbon material and a powdery conductive carbon material to adhere on the core material. A mixing method is not particularly limited and both of dry-mixing and wet-mixing can be used but a method by dry-mixing is preferred.

A mixing machine to perform the mixing is not particularly limited. However, when the mixing is conducted while applying shear force, a powdery conductive carbon material is to be uniformly dispersed and adhered to the surface of the core material without being aggregated. In addition, by further giving mechanical energy such as impact force and compressive force, it is expected that the surface coating layer comprising an amorphous carbon precursor and a powdery conductive carbon material is stabilized. That is, mixing by a device that can apply shear force and mechanical energy such as impact force and compressive force at the same time is preferable. For example, preferred are a high-speed agitator in which shear force and impact are applied to powder by a high-speed swirling flow, and a dry-blending mixer having a structure in which the space between the mixing blades and the internal wall of the container is narrow and powder is to be pressed to the internal wall of the container. Examples of such a mixing machine include Mechanofusion (trademark; manufactured by Hosokawa Micron Corporation), Nobilta (trademark; manufactured by Hosokawa Micron Corporation), Cyclomix (trademark; manufactured by Hosokawa Micron Corporation), COMPOSI (trademark; manufactured by NIPPON COKE & ENGINEERING CO., LTD.), a multipurpose mixer (manufactured by NIPPON COKE & ENGINEERING CO., LTD.), Mechano Hybrid (trademark; manufactured by NIPPON COKE & ENGINEERING CO., LTD.), Hybridization System (trademark; manufactured by Nara Machinery Co., Ltd.), Theta Composer (manufactured by TOKUJU CORPORATION), and Mechanomill (manufactured by Okada Seiko Co., Ltd.). In contrast, a V-shape mixer, a cone-shape mixer and a horizontal cylinder mixer, in which a container rotates; and a ribbon mixer, a screw mixer or a paddle mixer having mixing blades with a low rotation rate are not suitable for the above-described mixing purpose.

Next, a mixture of the core material composed of artificial graphite, the precursor of the amorphous carbon material, and the powdery conductive carbon material is fired at 600 to 1300° C., preferably 600 to 1100° C., more preferably 800 to 1100° C. By the firing, the precursor of the amorphous carbon material is carbonized and a coating layer comprising the non-powdery amorphous carbon material and the powdery conductive carbon material is formed on the surface of the core material.

When the firing temperature is too low, carbonization of the organic compound is not sufficiently completed, and hydrogen or oxygen remains in the coating layer to adversely affect the battery characteristics in some cases. In contrast, when the heat treatment temperature is too high, the sticking force of the coating layer to the core material becomes week and the coating layer tends to be peeled off. In addition, crystallization of the precursor of the amorphous carbon material excessively proceeds and charge characteristics tend to decline.

The heat treatment is preferably preformed under a non-oxidizing atmosphere. Examples of the non-oxidizing atmosphere include an atmosphere filled with an inert gas such as an argon gas or a nitrogen gas. The heat treatment time for firing can be appropriately selected depending on the production scale. For example, the time is 30 to 300 minutes, preferably 45 to 150 minutes.

In composite graphite particles in a preferable embodiment of the present invention, a ratio between the peak intensity of a peak in the vicinity of 1360 cm⁻¹ (1300 to 1400 cm⁻¹) (I_{D}) and the peak intensity of a peak in the vicinity of 1580 cm⁻¹ (1580 to 1620 cm⁻¹) (I_{G}) measured in a spectrum by Raman spectroscopy, I_{D}/I_{G} (R value) is preferably 0.10 to 1.00, more preferably 0.10 to 0.50, still more preferably 0.10 to 0.30. Here, the peak observed in the vicinity of 1580 cm⁻¹ is called G band, which corresponds to sp² bonds and indicates the presence of a carbon hexagonal plane structure. The peak observed in the vicinity of 1360 cm⁻¹ is called D band, which corresponds to spa bonds and indicates defects in a carbon hexagonal plane structure. When the peak intensity ratio I_{D}/I_{G} is 0.10 or more, a coating layer comprising a non-powdery amorphous carbon material and a powdery conductive carbon material is uniformly formed on the surface of graphite particles and an effect of improving output can be obtained. When the peak intensity ratio I_{D}/I_{G} is 1.00 or less, an excessively thick coating layer is not to be formed and the density of the negative electrode active material layer is not decreased when the electrode is pressed. As a result, a good discharge capacity and cycle characteristics of a battery can be obtained.

The BET specific surface area of the composite graphite particles in a preferable embodiment of the present invention is preferably 1.0 to 10.0 m²/g, more preferably 1.0 to 7.0 m²/g, still more preferably 1.0 to 5.0 m²/g. When the BET specific surface area is 1.0 m²/g or more, an appropriate contact area between the composite graphite particles and an electrolyte can be secured without being too small and good input/output characteristics can be obtained. When the BET specific surface area is 10.0 m²/g or less, the reaction area between the composite graphite particles and the electrolyte does not become too large and reduction in the initial efficiency and cycle characteristics of a battery due to excessive reduction of the electrolyte is not caused.

The 50% particle diameter (D₅₀) in the volume-based cumulative particle size distribution measured through laser diffractometry of the composite graphite particles in a preferable embodiment of the present invention is preferably from 5 μm to 30 μm, more preferably from 5 μm to 20 μm. D₅₀ of the composite graphite particles is rarely different from D₅₀ of the graphite particles of the core material because the thickness of the coating layer is several nanometers to tens nanometers.

[Paste]

A paste (slurry) for a negative electrode in a preferable embodiment of the present invention comprises the composite graphite particles, a binder, and a solvent. The paste is obtained by, for example, mixing and kneading composite graphite particles, the binder, and the solvent. The paste for a negative electrode may be formed into a sheet shape, a pellet shape, or the like as required.

The paste for a negative electrode in a preferable embodiment of the present invention preferably comprises a powdery conductive carbon material in addition to the composite graphite particles, the binder and the solvent. By including a powdery conductive carbon material in the negative electrode paste and consequently in a negative electrode sheet, pellet or the like, an effect of decreasing the contact resistance between the composite graphite particles is caused.

The blend ratio of the powdery conductive carbon material in the negative electrode paste is preferably 0.2 parts by mass to 5.0 parts by mass to 100 parts by mass of the total of composite graphite particles, a binder and the powdery conductive carbon material. The ratio is more preferably 0.2 parts by mass to 1.0 part by mass. When the ratio by mass of the powdery conductive carbon material is too high, it results in marked decrease in the density of the negative electrode active material when the negative electrode sheet obtained by molding the negative electrode paste is pressed. In addition, the initial efficiency of a lithium ion secondary battery using the negative electrode sheet tends to decrease. This is because the powdery conductive carbon material has a large irreversible capacity.

A powdery conductive carbon material contained in the negative electrode paste is carbon black or carbon fiber. Specifically, carbon black such as acetylene black and Ketjenblack, and carbon fiber such as carbon nanotubes and carbon nanofiber can be used. Of these, carbon black is preferred because it is inexpensive.

The paste in a preferable embodiment of the present invention can be suitably used for manufacturing an electrode, particularly a negative electrode, of a battery.

Examples of the binder include polyethylene, polypropylene, an ethylene propylene terpolymer, butadiene rubber, styrene butadiene rubber, butyl rubber, and a polymer compound having a large ionic conductivity. Examples of the polymer compound having a large ionic conductivity include polyvinylidene fluoride, polyethylene oxide, polyepichlorohydrin, polyphosphazene, and polyacrylonitrile. The blend ratio of the binder to the complex graphite particles is preferably from 0.5 part by mass to 20 parts by mass with respect to 100 parts by mass of the complex graphite particles.

The solvent is not particularly limited, and examples thereof include N-methyl-2-pyrrolidone, dimethylformamide, isopropanol and water. In the case of a binder using water as a solvent, a thickening agent is preferably used in combination. As a thickening agent, carboxymethylcellulose (CMC), methyl cellulose, polyacrylic acid and polyethylene glycol are exemplified. The amount of the solvent is adjusted so that the paste achieves such viscosity that the paste is easily applied onto a current collector.

[Electrode Sheet]

An electrode sheet in a preferred embodiment of the present invention comprises a formed body of the above-mentioned paste for an electrode. The electrode sheet is obtained, for example, by applying the above-mentioned paste for an electrode to a current collector, followed by drying and pressure forming.

Examples of the current collector include metal foils and mesh of aluminum, nickel, copper and the like. A conductive layer may be provided on the surface of the current collector. The conductive layer generally comprises a conductive additive and a binder.

There is no particular limitation for the paste coating method. The coating thickness of the paste (when it is dried) is generally 50 to 200 μm. When the coating thickness becomes too large, an electrode may not be accommodated in a standardized battery container.

Examples of the pressure forming include roll pressurization, plate pressurization, and the like. A pressure during the press forming is preferably from about 100 MPa to about 300 MPa (about 1 ton/cm² to about 3 ton/cm²). The electrode thus obtained is suitable for a negative electrode of a battery, in particular, a negative electrode of a secondary battery.

[Lithium Ion Secondary Battery]

A lithium ion secondary battery in a preferable embodiment of the present invention comprises the electrode sheet of the present invention as a negative electrode.

The battery or secondary battery in an embodiment of the present invention is described by taking a lithium ion secondary battery as a specific example. The lithium ion secondary battery has a structure in which a positive electrode and a negative electrode are soaked in an electrolytic solution or an electrolyte. As the negative electrode, the above-mentioned electrode is used.

In the positive electrode of the lithium ion secondary battery, a transition metal oxide containing lithium is generally used as a positive electrode active material, and preferably, an oxide mainly containing lithium and at least one kind of transition metal element selected from the group consisting of Ti, V, Cr, Mn, Fe, Co, Ni, Mo, and W, which is a compound having a molar ratio of lithium to a transition metal element of 0.3 to 2.2, is used. More preferably, an oxide mainly containing lithium and at least one kind of transition metal element selected from the group consisting of V, Cr, Mn, Fe, Co and Ni.

It should be noted that Al, Ga, In, Ge, Sn, Pb, Sb, Bi, Si, P, B, and the like may be contained in a range of less than 30% by mole with respect to the mainly present transition metal. Of the above-mentioned positive electrode active materials, it is preferred that at least one kind of material having a spinel structure represented by a general formula LiₓMO₂ (M represents at least one kind of Co, Ni, Fe, and Mn, and 0≤x≤1.2), or Li_{y}N₂O₄ (N contains at least Mn, and 0.02≤y≤2) be used.

Further, as the positive electrode active material, there may be particularly preferably used at least one kind of materials each including Li_{y}MₐD₁₋ₐO₂ (M represents at least one kind of Co, Ni, Fe, and Mn, D represents at least one kind of Co, Ni, Fe, Mn, Al, Zn, Cu, Mo, Ag, W, Ga, In, Sn, Pb, Sb, Sr, B, and P with the proviso that the element corresponding to M being excluded, y=0.02 to 1.2, and a=0.5 to 1) or materials each having a spinel structure represented by Li_{z}(Mn_{b}E_{1-b})₂O₄ (E represents at least one kind of Co, Ni, Fe, Al, Zn, Cu, Mo, Ag, W, Ga, In, Sn, Pb, Sb, Sr, B and P, b=1 to 0.2, and z=0 to 2).

Specifically, there are exemplified LiₓCoO₂, LiₓNiO₂, LiₓFeO₂, LiₓMnO₂, LiₓCoₐNi₁₋ₐO₂, LiₓCo_{b}V_{1-b}O₂, LiₓCo_{b}Fe_{1-b}O₂, LiₓMn₂O₄, LiₓMn_{c}Co_{2-c}O₄, LiₓMn_{c}Ni_{2-c}O₄, LiₓMn_{c}V_{2-c}O₄, and LiₓMn_{c}Fe_{2-c}O₄ (where, x=0.02 to 1.2, a=0.1 to 0.9, b=0.8 to 0.98, c=1.6 to 1.96, and z=2.01 to 2.3). As the more preferred transition metal oxide containing lithium, there are given LiₓCoO₂, LiₓNiO₂, LiₓFeO₂, LiₓMnO₂, LiₓCoₐNi₁₋ₐO₂, LiₓMn₂O₄, and LiₓCo_{b}V_{1-b}O_{z} (x=0.02 to 1.2, a=0.1 to 0.9, b=0.9 to 0.98). It should be noted that the value of x is a value before starting charge and discharge, and the value increases and decreases in accordance with charge and discharge.

Although 50% particle diameter (D₅₀) in the volume-based cumulative particle size distribution of the positive electrode active material is not particularly limited, the diameter is preferably 0.1 to 50 μm. It is preferred that the volume occupied by the particle group having a particle diameter of 0.5 to 30 μm be 95% or more of the total volume. It is more preferred that the volume occupied by the particle group having a particle diameter of 3 μm or less be 18% or less of the total volume, and the volume occupied by the particle group having a particle diameter of 15 μm to 25 μm be 18% or less of the total volume.

Although the specific area of the positive electrode active material is not particularly limited, the area is preferably 0.01 to 50 m²/g, more preferably 0.2 m²/g to 1 m²/g by a BET method. Further, it is preferred that the pH of a supernatant obtained when 5 g of the positive electrode active material is dissolved in 100 ml of distilled water be 7 or more and 12 or less.

In a lithium ion secondary battery, a separator may be provided between a positive electrode and a negative electrode. Examples of the separator include non-woven fabric, cloth, and a microporous film each mainly containing polyolefin such as polyethylene and polypropylene, a combination thereof, and the like.

As an electrolytic solution and an electrolyte forming the lithium ion secondary battery in an embodiment of the present invention, a known organic electrolytic solution, inorganic solid electrolyte, and polymer solid electrolyte may be used. An organic electrolytic solution is preferable from the viewpoint of electric conductivity.

As an organic electrolytic solution, preferred is a solution of an organic solvent such as: an ether such as diethyl ether, dibutyl ether, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, diethylene glycol dimethyl ether, ethylene glycol phenyl ether, 1,2-dimethoxyethane; an amide such as formamide, N-methylformamide, N,N-dimethylformamide, N-ethylformamide, N,N-diethylformamide, N-methylacetamide, N,N-dimethylacetamide, N-ethylacetamide, N,N-diethylacetamide, N,N-dimethylpropionamide, or hexamethylphosphorylamide; a sulfur-containing compound such as dimethylsulfoxide or sulfolane; a dialkyl ketone such as methyl ethyl ketone or methyl isobutyl ketone; a cyclic ether such as ethylene oxide, propylene oxide, tetrahydrofuran, 2-methoxytetrahydrofuran, or 1,3-dioxolan; a carbonate such as ethylene carbonate or propylene carbonate; γ-butyrolactone; N-methylpyrrolidone; acetonitrile; nitromethane; or the like. There are more preferably exemplified: esters such as ethylene carbonate, butylene carbonate, diethyl carbonate, dimethyl carbonate, propylene carbonate, vinylene carbonate, and γ-butyrolactone; ethers such as dioxolan, diethyl ether, or diethoxyethane; dimethylsulfoxide; acetonitrile; tetrahydrofuran; or the like. Particularly preferred is a nonaqueous solvent of carbonate such as ethylene carbonate or propylene carbonate. One kind of those solvents may be used alone, or two or more kinds thereof may be used as a mixture.

A lithium salt is used for a solute (electrolyte) of each of those solvents. Examples of a generally known lithium salt include LiClO₄, LiBF₄, LiPF₆, LiAlCl₄, LiSbF₆, LiSCN, LiCl, LiCF₃SO₃, LiCF₃CO₂, LiN(CF₃SO₂)₂, and the like.

Examples of the polymer solid electrolyte include a polyethylene oxide derivative and a polymer containing the derivative, a polypropylene oxide derivative and a polymer containing the derivative, a phosphoric acid ester polymer, a polycarbonate derivative and a polymer containing the derivative, and the like.

It should be noted that there is no constraint for the selection of members required for the battery configuration other than the aforementioned members.

### EXAMPLES

Hereinafter, the present invention is described in more detail by way of examples and comparative examples. It should be noted that these examples are merely for illustrative purposes, and the present invention is not limited to these examples. The physical properties of the composite graphite particles, the negative electrode properties and the battery properties were measured and evaluated by the methods given below.

(1) d₀₀₂

An X-ray diffraction peak was measured by an X-ray diffractometer (SmartLab (registered trademark) manufactured by Rigaku) under the conditions of Cu-Kα ray output of 30 kV and 200 mA. d₀₀₂ was calculated from the 002 diffraction peak according to JIS R 7651.

(2) I_{D}/I_{G} (R Value)

Through use of a laser Raman spectrometer (NRS-3100) manufactured by JASCO Corporation, a sample was irradiated with an argon laser having a wavelength of 532 nm and output of 7.4 mW and the Raman scattering light was measured with a spectrometer. The ratio (I_{D}/I_{G}) between the peak intensity of a peak in the vicinity of 1360 cm⁻¹ (1300 to 1400 cm⁻¹) (I_{D}) and the peak intensity of a peak in the vicinity of 1580 cm⁻¹ (1580 to 1620 cm⁻¹) (I_{G}) was calculated from the measured spectrum by Raman spectroscopy.

(3) Specific Surface Area

The specific surface area was calculated based on the measurement of the amount of nitrogen adsorption by a BET method.

(4) Particle Diameter

50% particle diameter (D₅₀) in the volume-based cumulative particle size distribution was determined by using laser diffraction type particle size distribution measuring apparatus (Mastersizer (registered trademark) produced by Malvern Instruments Ltd.).

(5) Production of Negative Electrode Sheet

To 97 Parts by mass of composite graphite particles, an aqueous dispersion of styrene-butadiene rubber (solid content of 40%) and 2 mass % aqueous solution of carboxymethyl cellulose (CMC, manufactured by Nippon Paper Industries Co., Ltd.; MAC-350-HC) were added so as to make each of styrene-butadiene rubber and CMC be 1.5 parts by mass in terms of a solid content. The resultant mixture was kneaded with a planetary mixer to provide a neat liquid paste.

N-methylpyrrolidone (NMP) was added to the neat liquid paste to adjust the viscosity and a paste was obtained. The paste was uniformly applied onto a high purity copper foil with a doctor blade and dried in vacuum at 120° C. for 1 hour to obtain a negative electrode sheet. The quantity for application was set so as to make the amount of the composite graphite particles be 6 to 7 mg/cm².

(6) Production of Coin Cell

The obtained negative electrode sheet was punched into a circular shape having a diameter of 16 mmΦ and compressed at a pressure of around 300 MPa (around 3 t/cm²) for 10 seconds to obtain a pressed negative electrode sheet.

The punched negative electrode sheet was introduced in a glove box filled with an argon gas, in which a dew point controlled to −80° C. or less. The negative electrode was placed in a coin cell case (CR2320, manufactured by Hohsen Corp.) and impregnated with an electrolyte (1M LiPF₆, ethylene carbonate (EC):methyl ethyl carbonate (MEC)=40:60 (volume ratio)). A polypropylene microporous film cut into a shape having a diameter of 20 mm and a 1.7 mm-thick lithium foil cut into a shape having a diameter of 17.5 mm were put on the negative electrode in this order. On top of that, a cap provided with a gasket was put, followed by caulking with a caulking machine, to fabricate a coin cell.

(7) Initial Efficiency of Battery

The produced coin cell was taken out from the glove box and left to stand at room temperature for 24 hours. Subsequently, the charge and discharge test of the work electrode is performed using the fabricated coin cell in a thermostatic bath set at 25° C.

First, after allowing a current of 0.05 C to pass until the open-circuit voltage reached 0.002 V, the charging is kept at 0.002 V and stopped when a current value drops to 25.4 pA to measure the charging capacity of the work electrode. Next, current of 0.05 C is allowed to pass until the open-circuit voltage reached 1.5 V to thereby measure the discharging capacity.

Based on the initial charge capacity and the initial discharge capacity in the charge/discharge cycle, the initial efficiency was calculated by the following formula.

(Initial efficiency)=(initial discharge capacity)/(initial charge capacity)

(8) Production of Laminate Cell

The following operation was performed in a glove box in which a dry argon gas atmosphere having a dew point of −80° C. or less was retained.

2 parts by mass of carbon black C45 (manufactured by TIMCAL), 3 parts by mass of carbon black KS6L (manufactured by TIMCAL) and 5 parts by mass (solid content) of polyvinylidene fluoride (KF polymer W#1300, manufactured by KUREHA CORPORATION) were mixed into 90 parts by mass of Li(Ni, Mn, Co)O₂ (manufactured by Umicore) as a positive electrode material. Subsequently, N-methyl-2-pyrrolidone (manufactured by KISHIDA CHEMICAL Co., Ltd.) was added thereto and kneaded to obtain a paste.

Using an automatic coating machine, the paste was applied onto a 20 μm-thick aluminum foil with a doctor blade having a clearance of 200 μm to produce a positive electrode.

The negative electrode and the positive electrode were laminated through the intermediary of a polypropylene separator (Celgard 2400, manufactured by Tonen Chemical Corporation). Next, an electrolyte was injected thereinto and an opening was sealed through thermal fusion in vacuum to obtain a laminate cell for evaluation.

(9) Cycle Characteristics of Battery

Tests were conducted using a laminate cell. The constant-current (CC) mode charging was performed at a constant current value of 50 mA (corresponding to 2 C) from a rest potential to a maximum voltage of 4.15 V. Next, the charging was switched to constant voltage (CV) charging mode with a cut off current value of 1.25 mA.

A discharging was performed in the constant-current mode at a current of 50 mA with a minimum voltage of 2.8 V.

The charge/discharge was repeated 100 cycles in a thermostat chamber set at 25° C. under the above-mentioned conditions to measure the discharge capacity. The ratio of the discharge capacity at the 100th cycle to the discharge capacity at the first cycle was defined as the capacity retention rate at the 100th cycle.

(10) Internal Resistance of Battery (DC-IR)

On the basis of the battery capacity obtained by the initial battery capacity (1 C=25 mAh), the constant-current (CC) mode discharging at 0.1 C was performed from a fully charged state at 0.1 C for three hours and a half (State of Charge (SOC) is 50%). After a rest of 30 minutes, discharging at 25 mA for five seconds was conducted to determine the Direct Current Internal Resistance (DC-IR) from the amount of voltage drop, ΔV, according to Ohm's law (R [Ω]=ΔV [V]/0.025 [A]).

### Example 1

Pulverized coal-based calcined needle coke was graphitized at 3,000° C. to obtain artificial graphite (d₀₀₂=0.3356 nm). 0.5 parts by mass of petroleum-based pitch (softening point: 230° C., ash content: 0.1 mass % or less, residual carbon ratio: 73.5%) and 0.5 parts by mass of carbon black C65 (manufactured by TIMCAL) were mixed into 100 parts by mass of the artificial graphite using Nobilta (trademark; manufactured by Hosokawa Micron Corporation) while applying shear force. The obtained mixture was fired at 1100° C. to obtain composite graphite particles comprising a core material composed of artificial graphite, and a coating material for coating the core material, which coating material comprises a non-powdery amorphous carbon material and a powdery conductive carbon substance (carbon black). BET specific surface area, Raman I_{D}/I_{G} (R value), particle diameter D₅₀ of the obtained composite graphite particles were measured. The conditions for forming composites and the measurement results of the physical properties of the composite graphite particles are shown in Table 1 and Table 2, respectively.

As the mass ratio of the non-powdery amorphous carbon material to the core material, the product of the blend ratio of pitch to the core material graphite and the residual carbon ratio was used. As the mass ratio of carbon black to the core material, the blend ratio of carbon black to the core material graphite was used.

A negative electrode was produced using the obtained composite graphite particles by the above-mentioned method for producing a negative electrode and a coin cell and a laminate cell were produced by the above-mentioned methods to measure the battery characteristics (initial efficiency, internal resistance, and cycle characteristics). The results are shown in Table 2.

### Example 2

A coin cell and a laminate cell were produced in the same way as in Example 1 except that a negative electrode sheet was produced by changing the composition of the neat liquid paste of the negative electrode to 96.5 parts by mass of composite graphite particles, an aqueous dispersion of styrene-butadiene rubber and an aqueous solution of carboxymethyl cellulose (CMC) each including styrene-butadiene rubber and CMC in an amount of 1.5 parts by mass in terms of a solid content, and 0.5 parts by mass of carbon black to thereby measure battery characteristics. The results are shown in Table 1 and Table 2.

### Example 3

Composite graphite particles were obtained in the same way as in Example 1 except that the ratio of the carbon black to be mixed into 100 parts by mass of artificial graphite was set to 1.0 part by mass. The physical properties of the composite graphite particles and the battery characteristics of the battery using the same were measured. The results are shown in Table 1 and Table 2.

### Example 4

Composite graphite particles were obtained in the same way as in Example 1 except that the ratio of the petroleum-based pitch and the ratio of carbon black to be mixed into 100 parts by mass of artificial graphite were each set to 3.0 parts by mass. The physical properties of the composite graphite particles and the battery characteristics of the battery using the same were measured. The results are shown in Table 1 and Table 2.

### Example 5

Composite graphite particles were obtained in the same way as in Example 1 except that the ratio of the petroleum-based pitch and the ratio of carbon black to be mixed into 100 parts by mass of artificial graphite were each set to 5.0 parts by mass. The physical properties of the composite graphite particles and the battery characteristics of the battery using the same were measured. The results are shown in Table 1 and Table 2.

### Comparative Example 1

Composite graphite particles were obtained in the same way as in Example 1 except that carbon black was not mixed into artificial graphite. The physical properties of the composite graphite particles and the battery characteristics of the battery using the same were measured. The results are shown in Table 1 and Table 2.

### Comparative Example 2

Composite graphite particles were obtained in the same way as in Example 2 except that carbon black was not mixed into artificial graphite. The physical properties of the composite graphite particles and the battery characteristics of the battery using the same were measured. The results are shown in Table 1 and Table 2.

### Comparative Example 3

Composite graphite particles were obtained in the same way as in Example 1 except that 18.0 parts by mass of the petroleum-based pitch and 20.0 parts by mass of carbon black were mixed into 100 parts by mass of artificial graphite. The physical properties of the composite graphite particles and the battery characteristics of the battery using the same were measured. The results are shown in Table 1 and Table 2.

### Comparative Example 4

Composite graphite particles were obtained in the same way as in Example 1 except that the ratio of the petroleum-based pitch and the ratio of carbon black to be mixed into 100 parts by mass of artificial graphite were each set to 8.0 parts by mass. The physical properties of the composite graphite particles and the battery characteristics of the battery using the same were measured. The results are shown in Table 1 and Table 2.

### Comparative Example 5

Composite graphite particles were obtained in the same way as in Example 1 except that the ratio of carbon black to be mixed into 100 parts by mass of artificial graphite was set to 0.1 parts by mass. The physical properties of the composite graphite particles and the battery characteristics of the battery using the same were measured. The results are shown in Table 1 and Table 2.

### Comparative Example 6

Composite graphite particles were obtained in the same way as in Example 1 except that, as to be mixed into 100 parts by mass of artificial graphite, the ratio of the petroleum-based pitch was set to 0.1 parts by mass and the ratio of carbon black was set to 1.0 part by mass. The physical properties of the composite graphite particles and the battery characteristics of the battery using the same were measured. The results are shown in Table 1 and Table 2.

### Comparative Example 7

As the core material graphite, natural graphite spherodized by mechanical treatment (d₀₀₂=0.3355 nm) was used. Composite graphite particles were obtained in the same way as in Example 1 except that the spherodized natural graphite, petroleum-based pitch and carbon black were mixed. The physical properties of the composite graphite particles and the battery characteristics of the battery using the same were measured. The results are shown in Table 1 and Table 2.

### Comparative Example 8

A coin cell and a laminate cell were produced in the same way as in Comparative Example 8 except that a negative electrode sheet was produced by changing the composition of the neat liquid paste of the negative electrode to 96.5 parts by mass of composite graphite particles, an aqueous dispersion of styrene-butadiene rubber and an aqueous solution of carboxymethyl cellulose (CMC) each including styrene-butadiene rubber and CMC in an amount of 1.5 parts by mass in terms of a solid content, and 0.5 parts by mass of carbon black to thereby measure battery characteristics. The results are shown in Table 1 and Table 2.

TABLE 1

| | | | | | | | | | Composition of composite graphite | |
|---|---|---|---|---|---|---|---|---|---|---|
| | | | | | | | Conditions for forming | | particles: Ratio to the core | |
| | | | | Blending ratio | | | composite | | material [mass %] | |
| | Core material graphite | | | [parts by mass] | | | | Firing | Non-powdery | |
| | | d002 | Lc | | | Carbon | Mixing | temperature | amorphous | Carbon |
| | Kind | [nm] | [nm] | Graphite | Pitch | black | method | [° C.] | carbon material | black |
| Example 1 | Artificial | 0.3356 | 192 | 100 | 0.5 | 0.5 | Nobilta | 1100 | 0.4 | 0.5 |
| | graphite | | | | | | | | | |
| Example 2 | Artificial | 0.3356 | 192 | 100 | 0.5 | 0.5 | Nobilta | 1100 | 0.4 | 0.5 |
| | graphite | | | | | | | | | |
| Example 3 | Artificial | 0.3356 | 192 | 100 | 0.5 | 1.0 | Nobilta | 1100 | 0.4 | 1.0 |
| | graphite | | | | | | | | | |
| Example 4 | Artificial | 0.3356 | 192 | 100 | 3.0 | 3.0 | Nobilta | 1100 | 2.2 | 3.0 |
| | graphite | | | | | | | | | |
| Example 5 | Artificial | 0.3356 | 192 | 100 | 5.0 | 5.0 | Nobilta | 1100 | 3.7 | 5.0 |
| | graphite | | | | | | | | | |
| Comparative | Artificial | 0.3356 | 192 | 100 | 0.5 | (Not added) | Nobilta | 1100 | 0.4 | (Not added) |
| Example 1 | graphite | | | | | | | | | |
| Comparative | Artificial | 0.3356 | 192 | 100 | 0.5 | (Not added) | Nobilta | 1100 | 0.4 | (Not added) |
| Example 2 | graphite | | | | | | | | | |
| Comparative | Artificial | 0.3356 | 192 | 100 | 18.0 | 20.0 | Nobilta | 1100 | 13.2 | 20.0 |
| Example 3 | graphite | | | | | | | | | |
| Comparative | Artificial | 0.3356 | 192 | 100 | 8.0 | 8.0 | Nobilta | 1100 | 5.9 | 8.0 |
| Example 4 | graphite | | | | | | | | | |
| Comparative | Artificial | 0.3356 | 192 | 100 | 0.5 | 0.1 | Nobilta | 1100 | 0.4 | 0.1 |
| Example 5 | graphite | | | | | | | | | |
| Comparative | Artificial | 0.3356 | 192 | 100 | 0.1 | 1.0 | Nobilta | 1100 | 0.1 | 1.0 |
| Example 6 | graphite | | | | | | | | | |
| Comparative | Natural | 0.3355 | 182 | 100 | 0.5 | 0.5 | Nobilta | 1100 | 0.4 | 0.5 |
| Example 7 | graphite | | | | | | | | | |
| Comparative | Natural | 0.3355 | 182 | 100 | 0.5 | 0.5 | Nobilta | 1100 | 0.4 | 0.5 |
| Example 8 | graphite | | | | | | | | | |

TABLE 2

| | | | | | Battery characteristics | | |
|---|---|---|---|---|---|---|---|
| | Physical properties of composite graphite particles | | | | | | Capacity |
| | | Specific | | Ratio of carbon black in the | Initial | | retention rate |
| | I_{D}/I_{G} | surface area | D₅₀ | negative electrode paste | efficiency | DC-IR | at 100^{th} cycle |
| | [R value] | [m²/g] | [μm] | (solid content) [mass %] | [%] | [Ω] | [%] |
| Example 1 | 0.12 | 2.0 | 15 | (Not added) | 93 | 0.89 | 97 |
| Example 2 | 0.12 | 2.0 | 15 | 0.5 | 92 | 0.82 | 97 |
| Example 3 | 0.15 | 2.4 | 15 | (Not added) | 92 | 0.85 | 96 |
| Example 4 | 0.28 | 2.9 | 15 | (Not added) | 90 | 0.78 | 92 |
| Example 5 | 0.37 | 3.7 | 16 | (Not added) | 88 | 0.77 | 90 |
| Comparative | 0.08 | 2.2 | 15 | (Not added) | 93 | 0.95 | 98 |
| Example 1 | | | | | | | |
| Comparative | 0.08 | 2.2 | 15 | 0.5 | 93 | 0.92 | 97 |
| Example 2 | | | | | | | |
| Comparative | 1.16 | 6.4 | 15 | (Not added) | 82 | 0.78 | 81 |
| Example 3 | | | | | | | |
| Comparative | 0.46 | 4.5 | 16 | (Not added) | 84 | 0.78 | 83 |
| Example 4 | | | | | | | |
| Comparative | 0.12 | 1.9 | 15 | (Not added) | 92 | 0.96 | 97 |
| Example 5 | | | | | | | |
| Comparative | 0.10 | 2.5 | 15 | (Not added) | 90 | 0.91 | 93 |
| Example 6 | | | | | | | |
| Comparative | 0.21 | 4.6 | 17 | (Not added) | 90 | 0.78 | 76 |
| Example 7 | | | | | | | |
| Comparative | 0.21 | 4.6 | 17 | 0.5 | 89 | 0.75 | 73 |
| Example 8 | | | | | | | |

By comparing Example 1 and Comparative Example 1, or Example 2 and Comparative Example 2 from the results shown in Table 1 and Table 2, it can be seen that the internal resistance is lowered in the case where carbon black is contained in the coating layer for covering the surface of composite graphite particles. Due to a lowered internal resistance of a battery, the battery exhibits a high capacity even at the time of charge/discharge under a large current and the battery output is improved.

When Example 1 and Example 2 are compared, it can be seen that a greater effect of reducing the internal resistance is obtained when carbon black is contained not only in the coating layer for covering the surface of composite graphite particles but also in the negative electrode (that is, negative paste).

With respect to cycle characteristics, when Example 1 and Comparative Example 1 are compared, there is very little decrease in the initial efficiency and the capacity retention rate at 100^{th} cycle due to integration of carbon black into graphite particles, and high durability of artificial graphite as the core material can be retained.

When Example 1, Example 4 and Example 5 are compared, as the amount of the amorphous carbon material obtained from a precursor of petroleum-based pitch and the amount of carbon black contained in the coating layer of composite graphite particles increase, the Raman R value of the surface of the composite graphite particles becomes higher and the internal resistance of the battery becomes lower. In contrast, the capacity retention rate at 100^{th} cycle is high and high durability is maintained.

However, when Example 3 is compared to Comparative Example 3 or Comparative Example 4, it can be seen that initial efficiency and the cycle characteristics of a battery are markedly deteriorated when carbon black is contained in the coating layer of composite graphite particles in an excessive amount, and such a material is unsuited for a negative electrode material for a lithium ion secondary battery. The lowest internal resistance value of the battery was observed in Example 5. It can be seen that there is little effect of reducing the internal resistance due to the increase in the mass of carbon black when an amorphous carbon material and carbon black are contained in composite graphite particles in an excessive amount.

When Example 1 and Comparative Example 5 are compared, an effect of reducing the internal resistance by the addition of carbon black cannot be obtained when the coating layer of the composite graphite particles contains a too small amount of carbon black.

When Example 3 and Comparative Example 6 are compared, the initial efficiency and the cycle characteristics of the battery were reduced when the coating layer of the composite graphite particles contains a too small amount of the amorphous carbon material obtained from a precursor of petroleum-based pitch. It is thought to be caused because carbon black does not adhere to the graphite surface or because carbon black is exposed without being coated by the amorphous carbon material.

When a comparison is made between Example 1 and Comparative Example 7 or between Example 2 and Comparative Example 8, it can be seen that, when natural graphite is used as a core material of composite graphite material, the cycle characteristics are markedly deteriorated. For this reason, natural graphite is unsuited for the core material of composite graphite particles of the present invention.

1. Composite graphite particles, comprising a core material composed of artificial graphite and a coating material for coating the core material, which coating material includes a non-powdery amorphous carbon material and a powdery conductive carbon material; wherein the ratio of the mass of the non-powdery amorphous carbon material to the mass of the core material is 0.2 to 3.8 mass %, and the ratio of the mass of the powdery conductive carbon material to the mass of the core material is 0.3 to 5.0 mass %; and wherein a ratio between the peak intensity of a peak in the vicinity of 1360 cm⁻¹ (I_{D}) and the peak intensity of a peak in the vicinity of 1580 cm⁻¹ (I_{G}) measured in a spectrum by Raman spectroscopy, I_{D}/I_{G} (R value), is 0.10 to 1.00.

2. The composite graphite particles according to claim 1, wherein the ratio of the mass of the non-powdery amorphous carbon material to the mass of the core material is 0.2 to 2.3 mass %.

3. The composite graphite particles according to claim 1, wherein the ratio of the mass of the powdery conductive carbon material to the ratio of the mass of the core material is 0.3 to 3.0 mass %.

4. The composite graphite particles according to claim 1, wherein the powdery conductive carbon material is carbon black.

5. (canceled)

6. The composite graphite particles according to claim 1, wherein a BET specific surface area based on nitrogen adsorption is 1.0 to 10.0 m²/g.

7. A method for producing the composite graphite particles according to claim 1, comprising adding 0.3 to 5.0 parts by mass of an amorphous carbon precursor and 0.3 to 5.0 parts by mass of a powdery conductive carbon material to 100 parts by mass of artificial graphite, mixing the resultant while applying shear force, and firing the obtained mixture at 600 to 1,300° C.

8. The method producing the composite graphite particles according to claim 7, wherein the amorphous carbon precursor is at least one compound selected from a group consisting of petroleum-based pitch, coal-based pitch, phenol resin, polyvinyl alcohol resin, furan resin, cellulose resin, polystyrene resin, polyimide resin and epoxy resin.

9. The method producing the composite graphite particles according to claim 8, wherein the amorphous carbon precursor is petroleum-based pitch.

10. A paste containing the composite graphite particles according to claim 1, a binder and a solvent.

11. The paste according to claim 10, further containing a powdery conductive carbon material.

12. An electrode sheet, which is composed of a laminate comprising a current collector and an electrode layer containing the composite graphite particles according to claim 1.

13. The electrode sheet according to claim 12, wherein the electrode layer further contains a powdery conductive carbon material.

14. A lithium ion secondary battery comprising the electrode sheet according to claim 12 as a negative electrode.
